(19) United States
(12) Patent Application Publication
(10) Pub. No.: US 2017/0221382 A1
(43) Pub. Date: Aug. 3, 2017

(54) SIMULATION SYSTEM USER INTERFACE

(71) Applicant: BAE System plc, London (GB)

(72) Inventors: Martin Alan JONES, Preston, Lancashire (GB); Andrew George NOTT, Preston, Lancashire (GB)

(21) Appl. No.: 15/515,192

(22) PCT Filed: Sep. 25, 2015
(86) PCT No.: PCT/GB2015/052791

§ 371 Date: Mar. 29, 2017

(30) Foreign Application Priority Data
Oct. 1, 2014 (GB) 1417329.8

(51) Int. Cl. G09B 19/24; H04L 29/06; G09B 9/22; G09B 9/00; G09B 9/16

(52) U.S. Cl. CPC G09B 19/24; G09B 9/003; G09B 9/16; G09B 9/22; H04L 67/38; G09B 9/08

(57) ABSTRACT

A user interface for a simulated wireless arrangement for communicating audio content in a distributed simulation process being a flight operation and control exercise performed by a plurality of simulation entities (8, 10) each representing a real-world entity from the following entity types: i) vehicles, ii) mission controllers, iii) airspace controllers; comprising: audio input and output means (24, 260) arranged for a human to input and receive output of speech during the distributed simulation process; and simulated wireless control input means (62, 90, 1 10), for use by the human operator to control the simulated wireless arrangement, comprising screen icons (64, 68, 70 72, 74, 76) adapted for the human operator to press, allowing control input related to one or more of: i) push-to-talk; ii) selection between a plurality of simulated wireless channels; iii) selection of respective simulated frequencies for the plurality of simulated wireless channels.

### FIELD OF THE INVENTION

The present invention relates to a user interface for use with transferring audio/voice communications data between different simulators in a simulation exercise, for example in a distributed simulation exercise.

### BACKGROUND

A known standard for transferring data between distributed sites and simulators for combat aircraft and other military assets is the Distributed Interactive Simulation (DIS) standard. DIS was originally published in 1995 by Simulation Interoperability Standards Organization (SISO) and subsequently up-issued in 1998 and 2012. In simple terms, one characteristic of DIS is that it defines the way in which three classes of data are transferred between simulators.

The three classes are as follows.

i) Entity State—The identity, position and velocity of vehicles, weapons, people, and so on. This is often referred to as “Ground Truth” since this information can always be precisely known to the simulations/exercise controllers/test directors. This may be contrasted with “perception/perceived data” where the location of vehicles sensed via some sensor (real or simulated) will be subject to measurement errors, transmission delays, line of sight issues, and so on.

ii) Audio/Voice Communications. This refers to the simulation of voice communications, which re typically via VHF radio in the real world systems being simulated. The DIS standard specifies that simulation data must transport recorded voice together with meta-data identifying frequency of broadcast and transmitter identity/location/transmission status to all radio software users.

iii) Tactical Data Link (TDL): This represents simulation of the messaging service of real world military aircraft via real standards such as Link 16. These messages convey, for example, tactical information such as threat and target locations and orders, mission data, status reports, and so on.

### SUMMARY OF THE INVENTION

The present inventors have realised that it would be desirable to provide enhanced ways in which the audio/voice communications data may be transferred between different simulators in a distributed simulation exercise. The present inventors have further realised it would be desirable if any one or more of the following considerations could also be included:

i) if the enhancement could be provided in a manner compliant with the existing requirements of DIS;

ii) if the enhancement could be provided in a manner that allowed it to be implemented simultaneously in different examples and types of simulators, preferably including different simulators where some or all were developed by different companies to represent dissimilar real world entities/platforms/vehicles for different uses;

iii) if the enhancement could be provided in a manner that allows some or all of the operators taking part in the simulation exercise (and technical support people) to communicate using familiar techniques such as push-to-talk (PTT), and/or frequency selection from among the many simulated frequencies required for a complex simulated battle space and the supporting technical channels required to support and co-ordinate the simulated mission;

iv) if the enhancement could be provided in a manner that enables it to be implemented with a wide variety of underlying software such as different computer operating systems (i.e. is “portable”);

v) if the enhancement could be provided in a manner that provided flexibility in areas such as configurable radio setups, many channels, interoperability, and so on;

vi) if the enhancement could provide additional features and functionality that are attractive in simulations (for examples features that are beneficial in a training or practice environment) but that are not desired or preferred in the real world implementation of the activity being simulated.

The present inventors have further realised it would be desirable if a graphical user interface (GUI) and/or the audio input (or inputs) and/or the audio output (or outputs) could be provided in a manner that gives increased usability to pilots and other operators including more realistic feel of use.

In a first aspect, the invention provides a user interface for a simulated wireless arrangement, wherein the simulated wireless arrangement is for communicating audio content in a distributed simulation process, wherein the distributed simulation process is a flight operation and control exercise performed by a plurality of simulation entities (8, 10) each representing a real-world entity, at least some of the real-world entities being from one or more of the following group of entity types: i) vehicles, ii) mission controllers, iii) airspace controllers; the user interface comprising: audio input and output means (24, 260) arranged for a human operator, whilst the human operator is operating the one of the simulation entities (8, 10) in the distributed simulation process, to input and receive output of speech during the distributed simulation process; and simulated wireless control input means (62, 90, 110), for use by the human operator, whilst the human operator is operating the one of the simulation entities (8, 10) in the distributed simulation process, to control the simulated wireless arrangement; the simulated wireless control input means comprising screen icons (64, 68, 70 72, 74, 76) adapted for the human operator to press, the icons (64, 68, 70 72, 74, 76) allowing control input related to one or more of the following group of functionalities of the simulated wireless arrangement: i) push-to-talk; ii) selection between a plurality of simulated wireless channels; iii) selection of respective simulated frequencies for the plurality of simulated wireless channels.

The user interface may be defined as a further simulation entity forming a further one of the plurality simulation entities defined for the distributed simulation process, arranged for the human operator to thereby control at least two of the simulation entities, one being the user interface and the other being an associated one of the plurality of simulation entities (8) that simulates a real-world entity from the following group of entity types: i) vehicles, ii) mission controllers, iii) airspace controller.

The user interface may comprise further icons (116, 118, 126, 128) allowing volume control input related to one or more of the following group of volume control functionalities of the simulated wireless arrangement: i) volume level control, ii) volume balance between left and right ear control, iii) feedback/sidetone level control.

The user interface may comprise further icons allowing text communication input.

The user interface may be arranged to allow a larger selection of input control possibilities compared to what is available in the real-world entity that the simulation entity (8) is simulating in the distributed simulation process.

The simulation entity (8) may be simulating an aircraft, and the human operator is performing simulated piloting of the aircraft.

The distributed simulation process may be performed according to a Distributed Interactive Simulation, DIS, as issued by the Simulation Interoperability Standards Organization, SISO.

In a further aspect, the invention provides a method for a simulated wireless arrangement, wherein the simulated wireless arrangement is for communicating audio content in a distributed simulation process, wherein the distributed simulation process is a flight operation and control exercise performed by a plurality of simulation entities (8, 10) each representing a real-world entity, at least some of the real-world entities being from one or more of the following group of entity types: i) vehicles, ii) mission controllers, iii) airspace controllers; the method comprising employing a user interface to implement: during the distributed simulation process, inputting and receiving output of speech via audio input and output means (24, 260) arranged for a human operator, whilst the human operator is operating the one of the simulation entities (8, 10) in the distributed simulation process, to provide the speech for input and receive the audio output; and simulated wireless control input means (62, 90, 110), for use by the human operator, whilst the human operator is operating the one of the simulation entities (8, 10) in the distributed simulation process, to control the simulated wireless arrangement; the simulated wireless control input means comprising screen icons (64, 68, 70 72, 74, 76) adapted for the human operator to press, the icons (64, 68, 70 72, 74, 76) allowing control input related to one or more of the following group of functionalities of the simulated wireless arrangement: i) push-to-talk; ii) selection between a plurality of simulated wireless channels; iii) selection of respective simulated frequencies for the plurality of simulated wireless channels.

The user interface may be defined as a further simulation entity forming a further one of the plurality simulation entities defined for the distributed simulation process, arranged for the human operator to thereby control at least two of the simulation entities, one being the user interface and the other being an associated one of the plurality of simulation entities (8) that simulates a real-world entity from the following group of entity types: i) vehicles, ii) mission controllers, iii) airspace controller.

The user interface may comprise further icons (116, 118, 126, 128) allowing volume control input related to one or more of the following group of volume control functionalities of the simulated wireless arrangement: i) volume level control, ii) volume balance between left and right ear control, iii) feedback/sidetone level control.

The user interface may comprise further icons allowing text communication input.

The method may comprise the human operator being provided with a larger selection of input control possibilities compared to what is available in the real-world entity that the simulation entity (8) is simulating in the distributed simulation process.

The simulation entity (8) may be simulating an aircraft, and the human operator is performing simulated piloting of the aircraft.

In a further aspect, the invention provides a program or plurality of programs arranged such that when executed by a computer system or one or more processors it/they cause the computer system or the one or more processors to operate in accordance with the method of any of the above aspects.

In a further aspect, the invention provides a machine readable storage medium storing a program or at least one of the plurality of programs according to the aspects of the preceding paragraph.

### BRIEF DESCRIPTION OF THE DRAWINGS

FIG. 1 is a schematic block diagram representation of a simulation network;

lo FIG. 2 is a schematic illustration (not to scale) showing certain elements of each of a plurality of primary entities that are shown in FIG. 1;

FIG. 3 is a schematic functional representation of one example of a primary entity where each block corresponds to a respective different function and where each block accordingly represents a respective functional module of the primary entity, and where each block may also be considered as representing a corresponding step or sub-process of a simulation process implemented by the primary entity;

FIG. 4 is a schematic illustration (not to scale) of a screen that displays various icons including a plurality of channel icons;

FIG. 5 is a schematic illustration (not to scale) of a frequency screen of a channel; and

FIG. 6 is a schematic illustration (not to scale) of a volume screen 110 of the channel whose frequency screen is shown in FIG. 5.

### DETAILED DESCRIPTION

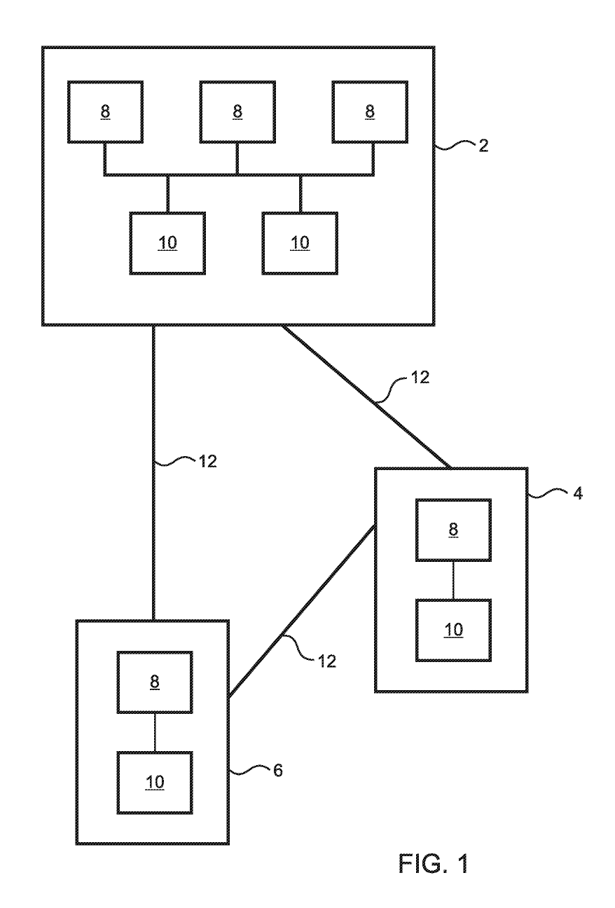

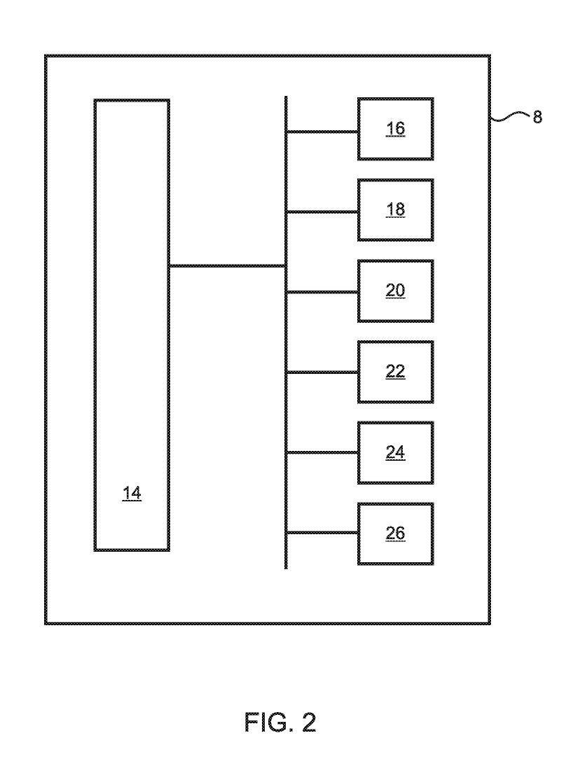

FIG. 1 is a schematic block diagram representation of a first embodiment of a simulation network 1. The simulation network 1 comprises a plurality of simulation entities (hereinafter referred to as entities). Each of the entities is, in this embodiment, located at one of three locations, namely a first location 2, a second location 4, or a third location 6.

In this embodiment the entities will be referred to, for convenience, as either a primary entity 8 or a secondary entity 10. In this embodiment the entities are located as follows: three primary entities 8 and two secondary entities 10 are coupled to each other and are located at the first location 2; one primary entity 8 and one secondary entity 10 are coupled to each other and located at the second location 4; and one primary entity 8 and one secondary entity 10 are coupled to each other and located at the third location 6.

In this embodiment, the three primary entities 8 at the first location 2 are simulation entities that each simulate a respective manned combat aircraft. In a simulation exercise, each of these aircraft simulation entities will be operated by a respective pilot undergoing training/practice. One of the secondary entities 10 at the first location 2 is a controller entity that will be operated by a training controller. The other of the secondary entities 10 at the first location 2 is a technical support entity that will be operated by a technical support person.

In this embodiment, at the second location 4, the primary entity 8 is a simulation entity that simulates a real-world Airborne Command & Control entity (such as, for example, the console of a Fighter Controller) and that will be operated by a person familiar with the required operation of the real-world Airborne Command & Control entity that is being simulated in the simulation exercise. The secondary entity 10 at the second location 4 is a technical support entity that will be operated by a technical support person.

In this embodiment, at the third location 6, the primary entity 8 is a simulation entity that simulates a real-world maritime or other type of airspace control system, for example: that of the Type 45 Destroyer, an Air Defence Destroyer. This primary entity 8 will be operated by a person familiar with the required operation of the corresponding real-world entity that is being simulated in the simulation exercise. The secondary entity 10 at the third location 6 is a technical support entity that will be operated by a technical support person.

In this embodiment the three locations 2, 4, 6 are located in three different parts of the same country, for example approximately 100-200 miles from each other. However, this need not be the case, for example in other embodiments they may be closer or further apart, and may be in different countries.

Network links 12 are provided between the different locations 2, 4, 6. The network links 12 may be provided by any suitable means, and the choice may be related to the protocols being employed in the simulation. In this embodiment the network links 12 are secure Internet Protocol (IP) connections using dedicated connections over the Internet.

FIG. 2 is a schematic illustration (not to scale) showing certain elements of each primary entity 8 (and the same elements may be comprised by each of the secondary entities 10).

In this embodiment the primary entity 8 is implemented as a personal computer, comprising the following elements coupled to each other in conventional fashion: a processor 14 (or plural processors); a memory 16 (or plural memories); a graphical user interface (GUI) 18, comprising one or more user input means, for example keyboard/keyboards, touch screen/touch screens, joystick, foot control bar/control bars, and so on, the GUI 18 further comprising one or more user output means, for example one or more displays (which may be in the form of the previously mentioned possibility of touch screen/touch screens), haptic outputs, and so on; a data input port 20 (or other data input means or plural data input ports/means); a data output port 22 (or other data output means or plural data output ports/means); an audio input 24 (for example an inbuilt microphone and associated electronics, or electronics for coupling to a microphone or microphones) (or plural audio inputs); and an audio output 26 (for example an inbuilt speaker and associated electronics, or electronics for coupling to a speaker or a headphone set) (or plural audio outputs). It is noted that the audio input (or inputs) 24 and audio output (or outputs) 26 may be considered as being part of the GUI 18, however for ease of reference they are described here as being separate items to the GUI.

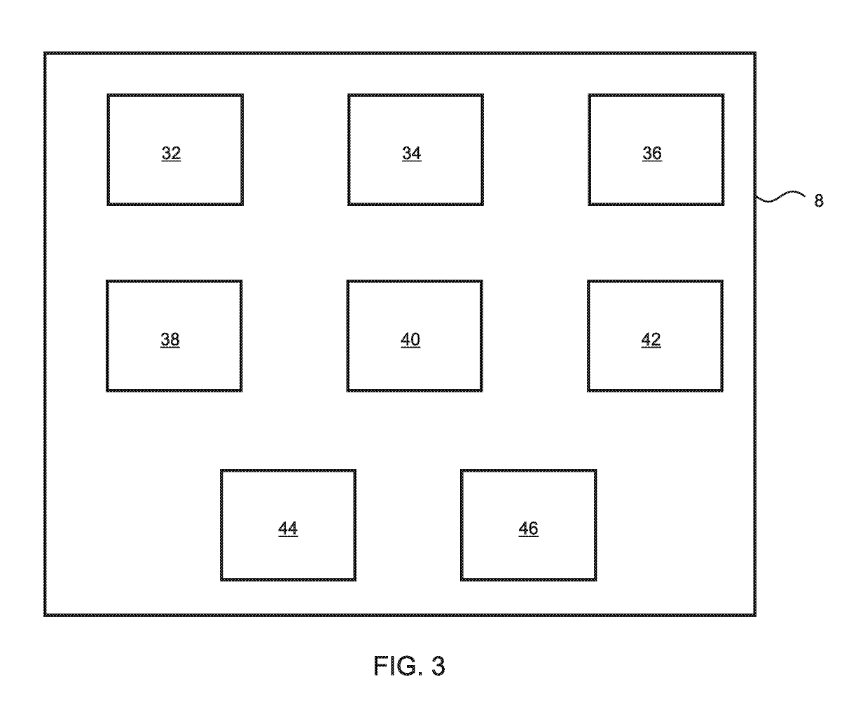

In this embodiment, a variety of simulation functions are provided by the operation of the above described elements of one or more of the primary entities 8 (and optionally one or more of the secondary entities 10). FIG. 3 is a schematic functional representation of one example of such a primary entity 8 where each block corresponds to a respective different function and where each block accordingly represents a respective functional module of the primary entity 8, and where each block may also be considered as representing a corresponding step or sub-process of a simulation process implemented by the primary entity 8.

In this embodiment the functional modules comprise the following: a multi-screen module 32; a channel module 34; a volume module 36; a PTT-activate module 38; a chat module 40, a configuration module 42; a fade module 44; and a cut-out module 44. However, in other embodiments, any one or more of the above mentioned modules may be omitted, and/or one or more further different modules may be included.

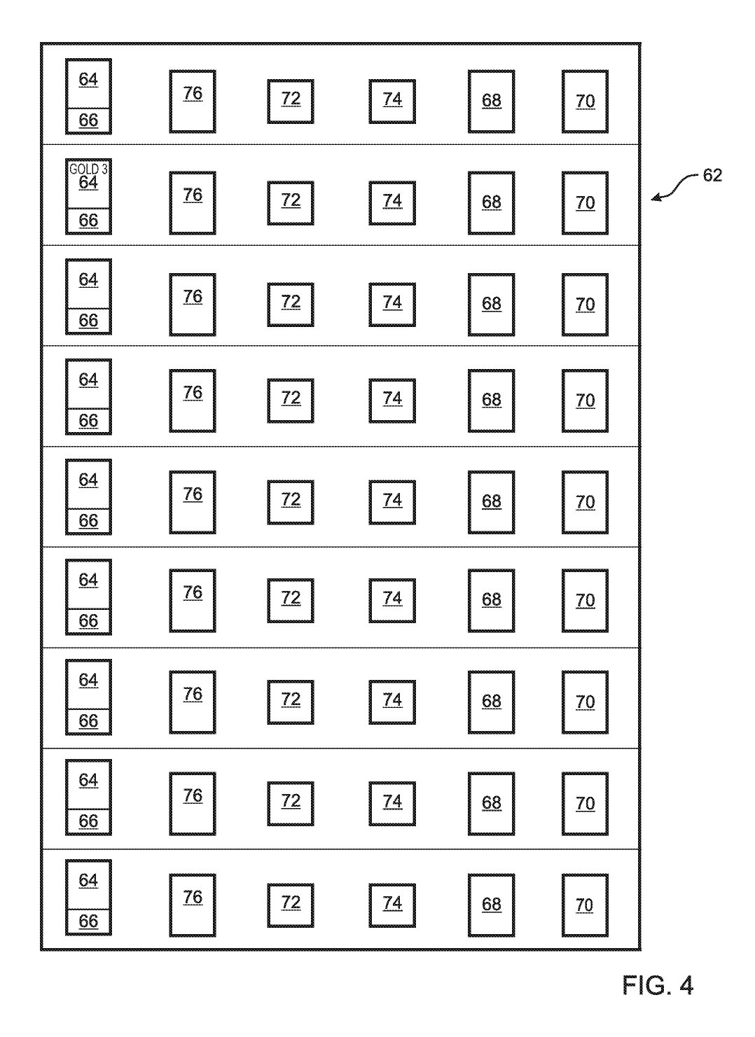

In this embodiment, a multiscreen GUI is provided by operation of the multi-screen module 32. In this embodiment, three views are provided as shown respectively in FIGS. 4, 5 and 6. It will be understood that the three screens may be displayed on separate areas of a common display device, or may be displayed on respective display devices. Another possibility is at different times only one or two (in any combination) may be displayed but not the remainder one(s). In this embodiment the screens are each implemented on touchscreens, and thereby at least some of the displayed icons are also input buttons. Another possibility is that only some of the displayed icons are also input buttons.

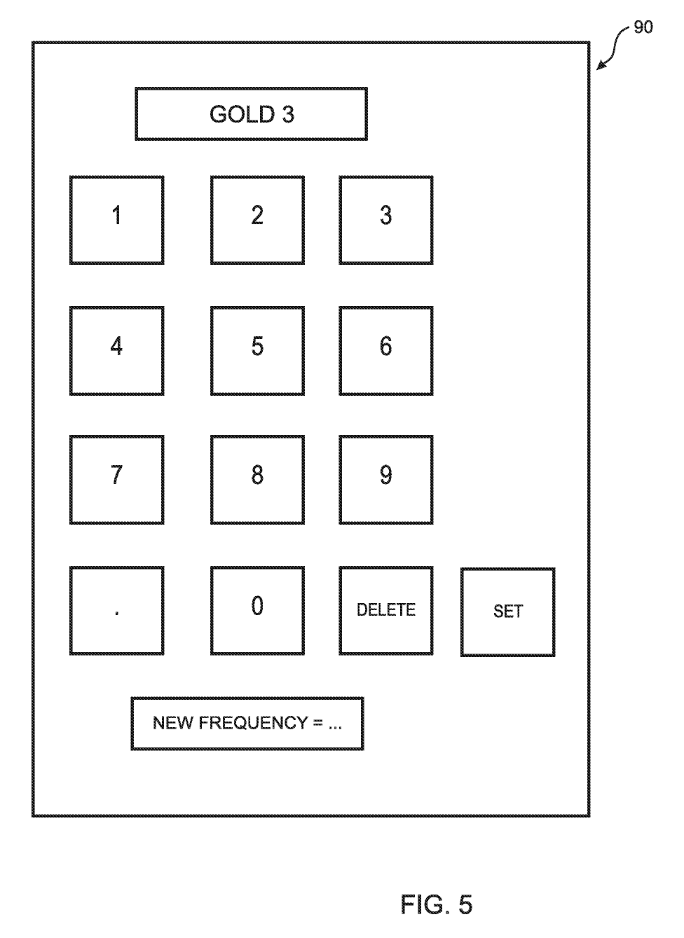

FIG. 4 is a schematic illustration (not to scale) of a first screen 62. A plurality of simulated radio channels (hereafter referred to as channels) is provided by operation of the channel module 34. The first screen 62 displays a plurality of channel icons 64 (each also serving as an input button), each channel icon 64 displaying an allocated name of a respective one of the channels and its selected (simulated) frequency value. The naming of the channels and the selection of the selected frequencies are implemented by the channel module 34. In this embodiment, when a user presses a channel icon 64 the display displays a second screen 90, which may conveniently be termed a frequency screen 90, which will be described later below with reference to FIG. 5.

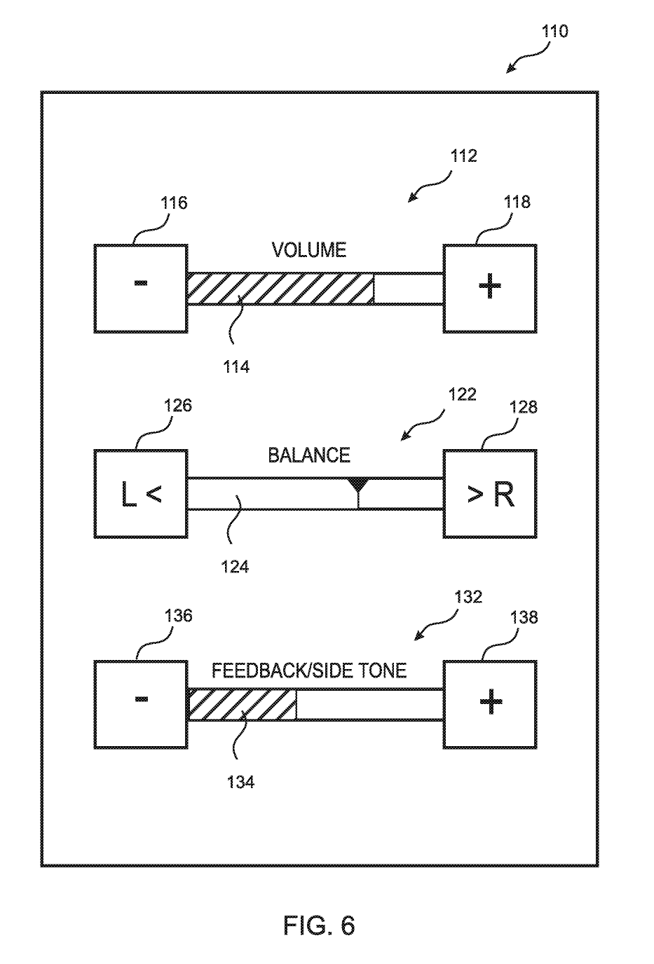

The first screen 62 further displays a plurality of volume level icons 66 (each also serving as an input button). Each volume level icon 66 is associated with a respective channel and hence also with a respective channel icon 64. Each volume level icon 66 displays a volume level indication for its respective channel, and also an indication of which of at which of user's left and/or right audio outputs (e.g. left and/or right earpiece of a set of headphones) the indicated volume level is being provided. In this embodiment, when a user presses a volume level icon 66 the display displays a third screen 110, which may conveniently be termed a volume screen 110, which will be described later below with reference to FIG. 6.

The first screen 62 further displays a plurality of volume screen select icons 68 (each also serving as an input button). Each volume screen select icon 68 is associated with a respective channel and hence also with a respective channel icon 64. In this embodiment, when a user presses a volume screen select icon 68 the display displays the volume screen 110, which will be described later below with reference to FIG. 5. That is, in this embodiment, a user may press either the volume level icon 66 or the volume screen select icon 68 to go to the volume screen 110.

The first screen 62 further displays a plurality of mute icons 70 (each also serving as an input button). Each mute icon 70 is associated with a respective channel and hence also with a respective channel icon 64. In this embodiment, when a channel is not muted, the mute icon 70 displays that a change to mute can be made and if a user presses the mute icon 70 the sound is muted on the associated channel; and vice-versa when a channel is already muted, the mute icon 70 displays that a change to unmuted can be made and if a user presses the mute icon 70 the sound is unmuted, i.e. restored to the level prior to muting, on the associated channel. In this embodiment, mute inhibits transmission automatically, as does reducing the volume past a low threshold. However, this needs not be the case in other embodiments.

The first screen 62 further displays a plurality of transmitting icons 72 and a plurality of receiving icons 74. Each transmitting icon 72 is associated with a respective receiving icon 74, and each associated pair of transmitting icon 72 and receiving icon 74 is associated with a respective channel and hence also with a respective channel icon 64. In this embodiment, when a channel is transmitting this is indicated by the transmitting icon 72 being in an indication state (e.g. highlighted or flashing), and when a channel is receiving this is indicated by the receiving icon 74 being in an indication state (e.g. highlighted or flashing). In this embodiment, the software can be configured to inhibit transmission on a channel while there is incoming audio being received on that channel in order to provide an approximation of real radio operation. This need not be the case in other embodiments.

The first screen 62 further displays a plurality of PTT icons 76 (each also serving as an input button). Each PTT icon 76 is associated with a respective channel and hence also with a respective channel icon 64. In this embodiment, a user presses the PTT icon 76 to provide for a voice input capability. In this embodiment, the primary mode comprises clicking and holding down (e.g. retaining pressure on a touch screen, or holding down a mouse button) the PTT icon 76 while talking and only releasing the PTT icon 76 after the user finishes talking, as in conventional real-world push-to-talk radios.

When the voice input capability is activated, this is indicated by the PTT icon 76 being in an indication state. In this embodiment, the PTT icon 76 is highlighted in a first colour, (for example red) when PTT is active. When PTT is not active, the previously used PTT is highlighted in a second different colour (for example purple) until either the same PTT icon 76 is clicked again, or a different PTT icon 76 is clicked. In other embodiments other indications may be employed. For example the previously used PTT may not be highlighted, and/or other indications such as flashing or other types of highlighting may be used instead.

In this embodiment the following optional, secondary, mode of operation is employed; however this need not be the case for other embodiments. This mode may be termed, for convenience, an “open microphone” arrangement. In addition to the primary mode of operation, a pre-determined keyboard combination may be pressed in order to change the state of the channel module 34 which is presently in use. In this secondary mode of operation, a single short press of the determined combination will toggle the transmitting state of the active channel module 34, and the active PTT icon 76. This mode may be termed “open microphone” because, contrary to the primary mode of operation, the key combination need not be held down for the duration of the period where the user is speaking. It must, however, be pressed again to terminate transmission. In this embodiment there is no mouse or touch screen based equivalent to this mode of operation, and the use of the keyboard combination to alter the state of the PTT icon 76 overrides any mouse or other input on the PTT icon 76. This need not be the case in other embodiments.

The PTT functions, including those indicated by the GUI aspects described in this paragraph and the preceding paragraph, are implemented by the PTT-activate module 38.

As mentioned earlier above, when a user presses the channel name icon 64 of the first screen 62, the frequency screen 90 is displayed. More particularly, a frequency screen 90 corresponding to the particular channel whose channel name icon 64 was pressed is displayed. By way of example, FIG. 5 is a schematic illustration (not to scale) of the frequency screen 90 of the channel whose name is “GOLD3”. Any appropriate GUI layout may be employed to allow a new frequency value to input for the respective channel. In this embodiment the touchscreen displays a numeric keyboard and enter (or set) button, and also displays the current frequency and the new value being input prior to the enter button being pressed. In this embodiment the channel module 34 does not allow the same frequency to be allocated to more than one channel. In this embodiment the following optional feature is implemented: frequency values may be input in either Hz or MHz—these are both accepted, and if a value is a decimal, e.g. 123.45, it is assumed to be MHz, whereas when a whole number is input, e.g. 123450000, is assumed to be Hz.

In this embodiment, the range of allowable frequencies (in Hz) far exceeds that of any single real world radio. This flexibility allows the DIS Radio to simulate a wide variety of radio networks, and has the added effect of allowing “short” or “memorable” frequencies (e.g. “101”) to be used for channels which do not require a realistic frequency to operate, for example those used for “behind the scenes” technical chatter.

As mentioned earlier above, when a user presses either the volume level icon 66 or the volume screen select icon 68, the volume screen 110 is displayed. More particularly, a volume screen 110 corresponding to the particular channel whose volume level icon 66 or volume screen select icon 68 was pressed is displayed. By way of example, FIG. 6 is a schematic illustration (not to scale) of the volume screen 110 of the channel whose name is “GOLD3”. In this embodiment the GUI format of the volume screen 110 is provided such that the following variables may be set:
“volume level”—a volume level for the audio that is output to the user; and
(ii) “volume balance”—a relative volume balance between the left and right audio outputs that are output to the user (e.g. to the left and right ears of the user's headphone set).

(iii) “feedback level” (which may also be termed “sidetone level”—a volume level for playing the user's own transmissions back to themselves. In this embodiment this volume applies to transmissions on all available channels. This feature is particularly advantageous for Air Traffic Controllers who typically expect hear their own transmissions. However, a further advantage is that other users may lower the level, including completely, using for example the controls described below.

Any appropriate GUI layout may be employed to allow the respective volume level, volume balance, and feedback level variables to be set and to have their values displayed. In this embodiment, and referring to FIG. 6, a volume level indication icon arrangement 112 is provided and comprises a value bar 114 showing the current volume level, a decrease button 116 and an increase button 118, these buttons 116 and 118 being for a user to decrease or increase the current volume level. Also in this embodiment, and again referring to FIG. 6, a volume balance indication icon arrangement 122 is provided and comprises a value bar 124 showing the current volume balance position, a decrease button 126 and an increase button 128, these buttons 126 and 128 being for a user to decrease or increase the level of the left ear output compared to the right ear output. Also in this embodiment, and again referring to FIG. 6, a feedback/sidetone level indication icon arrangement 132 is provided and comprises a value bar 134 showing the current feedback/sidetone level, a decrease button 136 and an increase button 138, these buttons 136 and 138 being for a user to decrease or increase the current feedback/sidetone level. In this embodiment the volume level, volume balance and feedback level controls are displayed on a separate screen in order to de-clutter the first screen 62, however this may not be the case and in other embodiments the plurality of volume controls for every channel may be displayed on the first screen 62.

Responding to input selections for the volume level, the volume balance, and the feedback/sidetone level, including implementing corresponding audio outputs at the selected levels and balances, and displaying their values on the first screen 62 and the volume screen 110, is implemented by the volume module 34.

The functions implemented in this embodiment by the chat module 40, the configuration module 42, the fade module 44, and the cut-out module 46 will now be described.

The chat module 40 implements text-based messaging between entities. The messages may be transmitted and received by the primary entities 8 and/or the secondary entities 10. However, typically, pilot's undergoing training and instruction will not tend to take part in text-based messaging, whereas in contrast this may be particularly useful for entities operated by controllers of the pilot instruction/training, and also for technical support entities. In this embodiment, the text-based messaging enables messages to be sent to one specific entity or to all of the entities participating in the simulation. All the messages that are sent and received are displayed in the order in which they were sent or received. In other embodiments, a message may be sent to one or more particular identified other entities (i.e. a subset of all the participating entities), or may be sent to all entities involved in a simulation exercise.

One possible use of the messaging arrangement is to send ping messages to determine the presence of other entities and/or to determine a message return time (and hence determine, if desired, network latency affecting overall simulation performance).

The configuration module 42 implements configuration functions. For example, in this embodiment, the channel frequencies are specified as an initial state in a configuration file, implemented for example as an Extensible Markup Language (XML) document. In some embodiments, changes that are then made during the simulation can then easily be stored and accommodated.

The fade module 44 implements an indication fade mode to some or all of the above described indications (for example the indications consisting of highlighting or lighting of a transmitting icon 72 or a receiving icon 74). Under the fade mode, when an indication is to be switched off, the indication is reduced to zero over a period of time, rather than being switched off substantially instantaneously. For example, if an icon when highlighted is “lit” with a given brightness, when the indication is to be removed, the brightness may be reduced back down to its normal “off” background level over a period of, for example, ten seconds. The reduction may be continuous or may alternatively step down through one or more decreasing discrete brightness levels. The fade mode tends to allow the pilot to notice indications he or she has missed due to distractions arising from the exercise/training environment, in particular when such distractions arise due to the differing circumstances of a simulation compared to a real flight, and yet more particularly when such distractions arise due to the added complexity provided by the per-channel variations, increased flexibility and increased features provided by at least some embodiments. Thus the fade mode tends to advantageously mitigate the disruptive effect to a pilot of the simulation environment and process compared to a real flight environment.

The cut-out module 46, in co-operation with the PTT-activate module 38, implements a function in which if the user presses the PTT icon 76 but then fails to speak, after a predetermined time the cut-out module 46 cuts out the talk facility, i.e. withdraws the voice input capability. Typically the cut-out function will only be implemented if the overall system has a sufficiently good audio quality to give reliable measurement of lack of speaking input from the user who has pressed the PTT icon 76. This cut-out functionality may be implemented in any appropriate manner. In some embodiments, it is implemented as described in the following paragraph.

The cut-out module 46 is an optional enhancement that reduces noise in the audio received by a user. This is achieved by examining the average volume of every sample of audio data as it is recorded, and by ignoring any sample which does not meet or exceed a predetermined (or otherwise determined) minimum volume threshold. Dropped audio samples never leave the sender and are not transmitted over the network. In some embodiments, it is only the audio data which is moderated; the radio state is not affected and will continue to advertise that the radio is on and transmitting until the PTT is released. In some embodiments, when enabled, the volume check is effectively active all the time, from the instant PTT is clicked, to the moment it is released, i.e. with volume checking enabled. If the PTT is clicked but nothing spoken, no data is sent at all. In some embodiments, the volume threshold is set in the configuration XML file and is tuned for the audio input equipment in use, and for the audio quality settings in use.

In some embodiments the first screen 62 and other screens may be displayed on a small display device which would be dedicated to displaying the radio, the size of which could be suitably matched to the application. In some embodiments the dedicated device is a touch sensitive screen but this does not have to be the case.

In some embodiments, the number of channels, and/or the number of variables that may be controlled for each channel (for example volume balance between right and left ears, mute capability, and so on), is specifically made higher than would be the case in the real world system that is being simulated. In particular, in some embodiments a pilot may be provided with more channels and/or more variables, thereby allowing the flexibility and other benefits of a training or practise simulation exercise to be increased.

In some embodiments, a further advantageous feature that is provided is that the PTT function is controlled by a simple input mechanism, either in addition to or instead of the PTT icon 76 described earlier above. One possibility is for the PTT function to be controlled by pressing of a space bar or other large key area on a keyboard. Another possibility is for the PTT function to be controlled by pressing of a foot pedal. Corresponding possibilities may in addition or instead be used to control the mute/unmute function. For all the options described in this paragraph, if desired the PTT icon 76 may still be employed to display which channel the user's PTT and/or mute/unmute input will be applied to.

The above embodiments may be implemented using any appropriate software and data processing techniques. One possibility is as follows. A commercially available DIS interface module is employed (for example, one such commercially available DIS interface module is “Open-DIS-Lite “An Open Source Implementation of the Distributed Interactive Simulation protocol” which may be obtained via http://open-dis.sourceforge.net/Open-DIS.html. DIS packets are put into local software objects (this may be implemented using JAVA, or any other appropriate programming language), which are then employed within the simulated radio.

In the current embodiment and as per DIS, each audio packet is associated with a “transmitter” (or “transmitter and receiver” object) which contains data such as the frequency in use, and the radio operational state. In this embodiment, each instance of the DIS radio emits a transmitter object (or transmitter and receiver object) for every radio channel which is configured. In other embodiments this need not be the case. In this embodiment the transmitter object (or transmitter and receiver object) is updated when a property such as frequency in use or transmitter state (on, on & transmitting, off) is changed. In the DIS specification, each transmitter object (or transmitter and receiver object) is “attached” to a physical entity in the simulation. In this embodiment the entity is provided by the radio simulation, however in other embodiments this need not be the case. The transmitter (or transmitter and receiver) adopts the location of the entity to which it is attached. Both the transmitter (or transmitter and receiver) and the attached entity can have their type specified using the standard DIS identifier object, which allows other simulation participants to look-up the type of entity and radio being simulated .

In some embodiments, a further advantageous feature that is provided is that computer generated (or operator generated) unmanned aircraft and/or other types of entities may be employed in the simulation in addition to the aircraft and other entities being controlled by pilots and other types of users (e.g. mission controllers), to provide additional complexity to the simulation.

In the above embodiments, the particular user interface implementations described above are described as being used by the particular simulator systems described above, in particular the different simulator functionalities and modules described above. However, this need not be the case, and in other embodiments the particular user interface implementation embodiments described above may be used by any other types of simulator systems, including simulator systems that do not include the functionalities and modules of the simulator systems described above.

Apparatus, including the primary entities 8 and the secondary entities 10, for implementing the above arrangements, and performing the processes described above, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

What is claimed is:

1. A user interface for a simulated wireless arrangement, wherein the simulated wireless arrangement is for communicating audio content in a distributed simulation process, wherein the distributed simulation process is a flight operation and control exercise performed by a plurality of first simulation entities each of the first simulation entities simulating a real-world entity, at least some of the real-world entities being from one or more of the following group of entity types: vehicles, mission controllers, airspace controllers, the user interface comprising:
an audio input and an audio output configured to enable a human operator, whilst the human operator is operating the a selected one of the simulation entities in the distributed simulation process, to input and receive output of speech during the distributed simulation process; and
a simulated wireless control input configured to enable the human operator, whilst the human operator is operating an associated one of the first simulation entities in the distributed simulation process, to control the simulated wireless arrangement;
the simulated wireless control input comprising screen icons adapted for the human operator to press, the icons allowing control input related to one or more of the following group of functionalities of the simulated wireless arrangement:
push-to-talk;
selection between a plurality of simulated wireless channels; and
selection of respective simulated frequencies for the plurality of simulated wireless channels.

2. The user interface according to claim 1, wherein the user interface is defined as a further simulation entity, human operator being thereby able to control the user interface and the associated one of the plurality of simulation entities.

3. The user interface according to claim 1, wherein the screen icons further comprise icons allowing volume control input related to one or more of the following group of volume control functionalities of the simulated wireless arrangement:
i) volume level control;
ii) volume balance between left and right ear control;
iii) feedback/sidetone level control.

4. The user interface according to claim 1, wherein the screen icons further comprise icons allowing text communication input.

5. The user interface according to claim 1, wherein the simulated wireless control input provides to the human operator a selection of input control possibilities that is larger than a selection of input control possibilities provided by the real-world entity that the associated one of the first simulation entitites is simulating in the distributed simulation process.

6. The user interface according to claim 1, wherein the associated one of the simulation entities is simulating an aircraft, and the human operator is performing simulated piloting of the aircraft.

7. The user interface according to claim 1, wherein the distributed simulation process is performed according to a Distributed Interactive Simulation, DIS, as issued by the Simulation Interoperability Standards Organization, SISO.

8. A method for controlling a simulated wireless arrangement, wherein the simulated wireless arrangement is configured for communicating audio content in a distributed simulation process, wherein the distributed simulation process is a flight operation and control exercise performed by a plurality of first simulation entities each representing a real-world entity, at least some of the first real-world entities being from one or more of the following group of entity types: vehicles, mission controllers, airspace controllers, the method comprising:
while a human operator is operating an associated one of the first simulation entities during the distributed simulation process, employing by the human user of a user interface to implement:
input and receive output of speech via an audio input and output; and
control the simulated wireless arrangement using a simulated wireless control input;
the simulated wireless control input comprising screen icons adapted for the human operator to press, the screen icons allowing control input related to one or more of the following functionalities of the simulated wireless arrangement:
push-to-talk;
selection between a plurality of simulated wireless channels; and
selection of respective simulated frequencies for the plurality of simulated wireless channels.

9. The method according to claim 8, wherein the user interface is defined as a further simulation entity the human operator being thereby able to control the user interface and the associated one of the plurality of first simulation entities.

10. The method according to claim 8, wherein the user interface further comprises icons that enable volume control input related to one or more of the following control functionalities of the simulated wireless arrangement:
volume level control;
volume balance between left and right ear control; and
feedback/sidetone level control.

11. The method according to claim 8, wherein the user interface further comprises icons that enable text communication input.

12. The method according to claim 8, wherein the user interface provides to the human operator a selection of input control possibilities that is larger than a selection of input control possibilities provided by the real-world entity that the associated one of the first simulation entities is simulating in the distributed simulation process.

13. The method according to claim 8, wherein the associated on of the first simulation entities is simulating an aircraft, and the human operator is performing simulated piloting of the aircraft.

14. In a distributed simulation process, wherein the distributed simulation process is a flight operation and control exercise performed by a plurality of first simulation entities each representing a real-world entity, at least some of the first real-world entities being from one or more of the following group of entity types: vehicles, mission controllers, airspace controllers, non-transient media containing instructions operable by a computer system or one or more processors so as to cause the computer system or the one or more processors, while a human operator is operating an associated one of the first simulation entities during the distributed simulation process, to provide to the human operator a user interface enabling the human operator to:
input and receive output of speech via an audio input and output; and
control the simulated wireless arrangement using a simulated wireless control input;
the simulated wireless control input comprising screen icons adapted for the human operator to press, the screen icons allowing control input related to one or more of the following functionalities of the simulated wireless arrangement:
push-to-talk;
selection between a plurality of simulated wireless channels; and
selection of respective simulated frequencies for the plurality of simulated wireless channels.

15. (canceled)
